(19) United States
(12) Patent Application Publication
(10) Pub. No.: US 2005/0162369 A1
(43) Pub. Date: Jul. 28, 2005

(54) Apparatus and method of driving display device

(76) Inventors: Moung-Su Kim, Suwon-si (KR); Seung-Woo Lee, Seoul (KR)

Correspondence Address: CANTOR COLBURN, LLP, 55 GRIFFIN ROAD SOUTH, BLOOMFIELD, CT, 06002, US

(21) Appl. No.: 11/016,393

(22) Filed: Dec. 17, 2004

(30) Foreign Application Priority Data
Dec. 18, 2003 (KR) 10-2003-0093253

(51) Int. Cl. G09G 3/36

(52) U.S. Cl. 345/98

(57) ABSTRACT

A display device is provided, which includes: a display panel including a plurality of pixels; a memory storing a plurality of FRC data patterns; a signal controller that reads out the FRC patterns, stores the FRC patterns therein, selects one of the FRC data patterns based on input image data having a first bit number and converting the input image data into output image data having a second bit number smaller than the first bit number based on the selected FRC data pattern; and a data driver applying data voltages corresponding to the output image data supplied from the signal controller to the pixels, wherein the selection of the FRC data pattern is based on the lower bit data having a third bit number of the input image data and the frame number.

### BACKGROUND OF THE INVENTION

(a) Field of the Invention

The present invention relates to an apparatus and a method of driving a liquid crystal display.

(b) Description of Related Art

A flat panel display such as a liquid crystal display (LCD) and an organic light emitting display (OLED) includes a display panel, a plurality of drivers for driving the display panel, and a controller for controlling the drivers.

An LCD includes two panels having pixel electrodes and a common electrode and a liquid crystal (LC) layer with dielectric anisotropy, which is interposed between the two panels. The pixel electrodes are arranged in a matrix, connected to switching elements such as thin film transistors (TFTs), and supplied with data voltages through the switching elements. The common electrode covers entire surface of one of the two panels and is supplied with a common voltage. The pixel electrode, the common electrode, and the LC layer form a LC capacitor in circuital view, which is a basic element of a pixel along with the switching element connected thereto.

In the LCD, the two electrodes supplied with the voltages generate electric field in the LC layer, and the transmittance of light passing through the LC layer is adjusted by controlling the strength of the electric field, thereby obtaining desired images. In order to prevent image deterioration due to the unidirectional electric field, polarity of the data voltages with respect to the common voltage is reversed every frame, every row, or every dot.

The display device receives digital input image data for red, green, and blue colors from an external graphics source, respectively. A signal controller of the display device converts the format of the input image data and supplies the converted image data to a data driver. The data driver converts the digital image data into analog data voltages and applies the data voltages to the pixels.

The bit number of the input image data from the graphics source may not be equal to that of the image data capable of being processed in the data driver. For example, a data driver capable of only 6-bit data is commonly used for reducing the manufacturing cost, while the bit number of the input image data is eight.

In order to convert the 8-bit image data into the 6-bit image data capable of being processed in the data driver, it is proposed that FRC (frame rate control) should be applied for use in the display device.

FRC represents high-bit data as low-bit data and their temporal and spatial arrangements. For FRC, the signal controller modifies a high-bit input data in a frame for a pixel into a low-bit data depending on the position of the pixel and the serial number of the frame. A pattern containing the modification data as function of the position of the pixel and the serial number of the frame, which is stored in a memory such as a frame memory, is called FRC pattern.

Such FRC pattern is determined in consideration of the characteristics of the display device and it is hard to find an optimal pattern for the display device.

Furthermore, it is hard to change the FRC pattern whenever the operating characteristics of the display device are changed due to the limit of time and cost.

### SUMMARY OF THE INVENTION

A display device is provided, which includes: a display panel including a plurality of pixels; a memory storing a plurality of FRC data patterns; a signal controller that reads out the FRC patterns, stores the FRC patterns therein, selects one of the FRC data patterns based on input image data having a first bit number and converting the input image data into output image data having a second bit number smaller than the first bit number based on the selected FRC data pattern; and a data driver applying data voltages corresponding to the output image data supplied from the signal controller to the pixels, wherein the selection of the FRC data pattern is based on the lower bit data having a third bit number of the input image data and the frame number.

The signal controller may further include: a look-up table temporarily storing the FRC data patterns read out from the memory; and a data processor converting the input image data into the output image data based on the FRC data patterns stored into the look-up table.

Each FRC data pattern may have an n×n data matrix form where n is equal to or larger than four. The difference between the first bit number and the second number may be equal to two and n may be equal to four, and the third bit number may be equal to two.

The FRC data patterns stored into the memory may include FRC data patterns for values “01” and “10” of the lower bit data. When the lower bit data has a value “00,” the data processor may determine upper bit data of the input image data extracting out the lower 2-bit data as the output image data, and when the lower bit data has the value “11,” the data processor may determine the output image data by using a data value obtained by inverting a data value of the FRC data patterns for the lower bit data having the value “01.”

The difference between the first bit number and the second bit number may be three, and n may be eight.

The memory may include an EEPROM (electrically erasable and programmable read only memory).

A method for driving a display device is provided, which includes: reading out a plurality of FRC data patterns from an external device; storing the read FRC data patterns; reading out a value of lower bit data of input image data including upper bit data of the first bit number and the lower bit data of the second bit number; selecting one of the FRC data patterns based on the lower bit data; reading out a data value from the selected FRC data pattern corresponding to the input image data; determining output image data as the upper bit data or the upper bit data added by one; and outputting the output image data.

Each FRC data pattern may have an n×n data matrix form where n is equal to or larger than 4.

The difference between the first bit number and the second bit number may be equal to two and n may be equal to 4.

The FRC data patterns stored into the memory may include FRC data patterns for values “01” and “10” of the lower bit data. When the lower bit data has a value “00,” the data processor may determine upper bit data of the input image data extracting out the lower 2-bit data as the output image data, and when the lower bit data has the value “11,” the data processor may determine the output image data by using a data value obtained by inverting a data value of the FRC data patterns for the lower bit data having the value “01.”

### BRIEF DESCRIPTION OF THE DRAWINGS

The present invention will become more apparent by describing embodiments thereof in detail with reference to the accompanying drawing in which:

FIG. 1 is a block diagram of an LCD according to an embodiment of the present invention;

FIG. 2 is an equivalent circuit diagram of a pixel of an LCD according to an embodiment of the present invention;

FIG. 3 is a set of FRC data patterns stored in a look-up table of a signal controller according to an embodiment of the preset invention; and

FIG. 4 is a flow chart of a data processor according to an embodiment of the present invention.

### DETAILED DESCRIPTION OF EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

Then, apparatus and methods of driving a liquid crystal display according to embodiments of the present invention will be described with reference to the accompanying drawings.

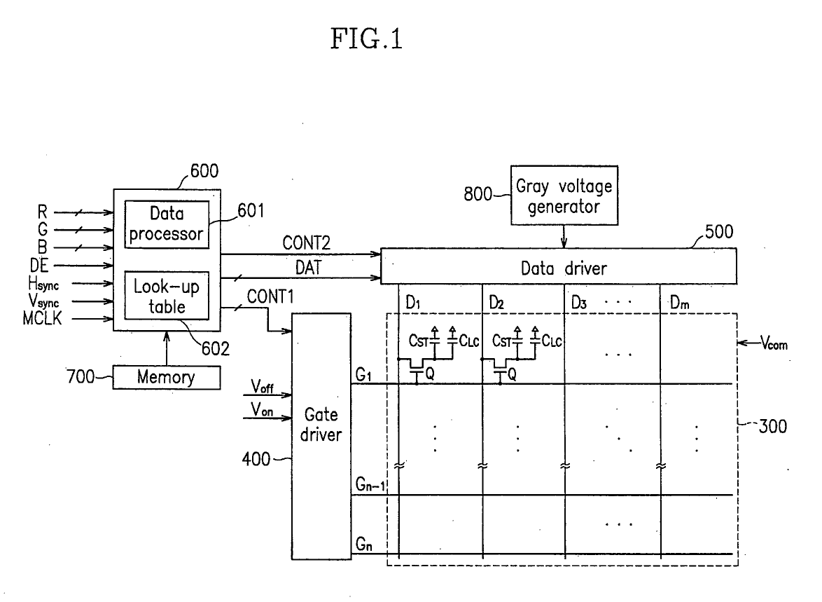

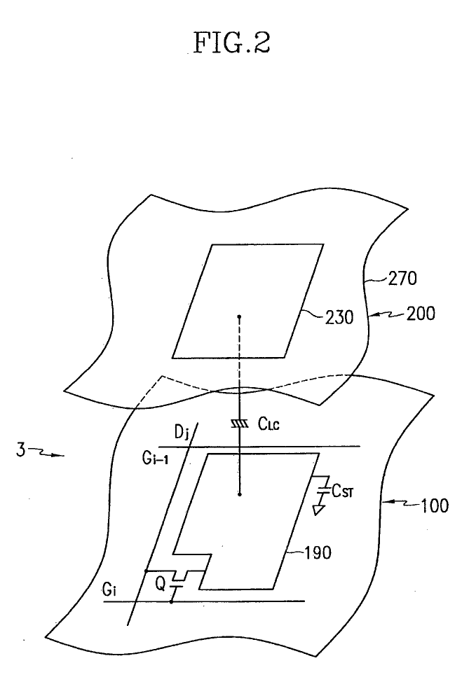

FIG. 1 is a block diagram of an LCD according to an embodiment of the present invention, and FIG. 2 is an equivalent circuit diagram of a pixel of an LCD according to an embodiment of the present invention.

Referring to FIG. 1, an LCD according to an embodiment includes a LC panel assembly 300, a gate driver 400 and a data driver 500 that are connected to the panel assembly 300, a gray voltage generator connected to the data driver 500, a signal controller 600 controlling the above elements, and a memory 700 connected to the signal controller 600.

Referring to FIG. 1, the panel assembly 300 includes a plurality of display signal lines G₁-Gₙ and D₁-Dₘ and a plurality of pixels connected thereto and arranged substantially in a matrix. In a structural view shown in FIG. 2, the panel assembly 300 includes lower and upper panels 100 and 200 and a LC layer 3 interposed therebetween.

The display signal lines G₁-Gₙ and D₁-Dₘ are disposed on the lower panel 100 and include a plurality of gate lines G₁-Gₙ transmitting gate signals (also referred to as “scanning signals” ), and a plurality of data lines D₁-Dₘ transmitting data signals. The gate lines G₁-Gₙ extend substantially in a row direction and substantially parallel to each other, while the data lines D₁-Dₘ extend substantially in a column direction and substantially parallel to each other.

Each pixel includes a switching element Q connected to the signal lines G₁-Gₙ and D₁-Dₘ, and a LC capacitor CLc and a storage capacitor CST that are connected to the switching element Q. If unnecessary, the storage capacitor CST may be omitted.

The switching element Q including a TFT is provided on the lower panel 100 and has three terminals: a control terminal connected to one of the gate lines G₁-Gₙ; an input terminal connected to one of the data lines D₁-Dₘ; and an output terminal connected to both the LC capacitor C_{LC} and the storage capacitor C_{ST}.

The LC capacitor C_{LC} includes a pixel electrode 190 provided on the lower panel 100 and a common electrode 270 provided on an upper panel 200 as two terminals. The LC layer 3 disposed between the two electrodes 190 and 270 functions as dielectric of the LC capacitor C_{LC}. The pixel electrode 190 is connected to the switching element Q, and the common electrode 270 is supplied with a common voltage Vcom and covers an entire surface of the upper panel 200. Unlike FIG. 2, the common electrode 270 may be provided on the lower panel 100, and both electrodes 190 and 270 may have shapes of bars or stripes.

The storage capacitor C_{ST} is an auxiliary capacitor for the LC capacitor C_{LC}. The storage capacitor C_{ST} includes the pixel electrode 190 and a separate signal line, which is provided on the lower panel 100, overlaps the pixel electrode 190 via an insulator, and is supplied with a predetermined voltage such as the common voltage Vcom. Alternatively, the storage capacitor C_{ST} includes the pixel electrode 190 and an adjacent gate line called a previous gate line, which overlaps the pixel electrode 190 via an insulator.

For color display, each pixel uniquely represents one of primary colors (i.e., spatial division) or each pixel sequentially represents the primary colors in turn (i.e., temporal division) such that spatial or temporal sum of the primary colors are recognized as a desired color. An example of a set of the primary colors includes red, green, and blue colors. FIG. 2 shows an example of the spatial division that each pixel includes a color filter 230 representing one of the primary colors in an area of the upper panel 200 facing the pixel electrode 190. Alternatively, the color filter 230 is provided on or under the pixel electrode 190 on the lower panel 100.

One or more polarizers (not shown) are attached to at least one of the panels 100 and 200.

Referring to FIG. 1 again, the gray voltage generator 800 generates two sets of a plurality of gray voltages related to the transmittance of the pixels. The gray voltages in one set have a positive polarity with respect to the common voltage Vcom, while those in the other set have a negative polarity with respect to the common voltage Vcom.

The gate driver 400 is connected to the gate lines G₁-Gₙ of the panel assembly 300 and synthesizes the gate-on voltage Von and the gate-off voltage Voff from an external device to generate gate signals for application to the gate lines G₁-Gₙ.

The data driver 500 is connected to the data lines D₁-Dₘ of the panel assembly 300 and applies data voltages, which are selected from the gray voltages supplied from the gray voltage generator 800, to the data lines D₁-Dₘ.

The drivers 400 and 500 may include at least one integrated circuit (IC) chip mounted on the panel assembly 300 or on a flexible printed circuit (FPC) film in a tape carrier package (TCP) type, which are attached to the LC panel assembly 300. Alternately, the drivers 400 and 500 may be integrated into the panel assembly 300 along with the display signal lines G₁-Gₙ and D₁-Dₘ and the TFT switching elements Q.

The memory 700 stores a plurality of FRC data patterns and may include an EEPROM (electrically erasable and programmable read only memory).

The signal controller 600 controls the gate driver 400 and the data driver 500 and it includes a data processor 601 and a look-up table 602.

Now, the operation of the LCD will be described in detail.

The signal controller 600 reads out the FRC data patterns from the external memory 700 and stores them into the look-up table 602. Then, the signal controller 600 receives input image data R, G and B and input control signals controlling the display thereof such as a vertical synchronization signal Vsync, a horizontal synchronization signal Hsync, a main clock MCLK, and a data enable signal DE, from an external graphics controller (not shown). After generating gate control signals CONT1 and data control signals CONT2 and processing the image data R, G and B suitable for the operation of the panel assembly 300 on the basis of the input control signals and the input image data R, G and B, the signal controller 600 provides the gate control signals CONT1 for the gate driver 400, and the processed image data DAT and the data control signals CONT2 for the data driver 500.

The data processing of the signal controller 600 includes FRC using the FRC data patterns stored in the look-up table 602. FRC takes upper bits of the input image data and makes remaining lower bits to be represented as temporal and spatial arrangements of the taken upper bits, when the bit number of image data capable of being processed by the data driver 500 is smaller than that of the input image data R, G, and B. For example, when the bit number of the input image data R, G, and B is eight and the bit number of image data capable of being processed by the data driver 500 is six, the signal controller 600 may convert an 8-bit image data in a frame for a pixel into a 6-bit image data that has a value equal to or larger than by one upper six bits of the 8-bit image data and determined by lower two bits of the 8-bit image data, the position of the pixel, the serial number of the frame. FRC will be described later in detail.

The gate control signals CONT1 include a scanning start signal STV for instructing to start scanning and at least a clock signal for controlling the output time of the gate-on voltage Von. The gate control signals CONT1 may further include an output enable signal OE for defining the duration of the gate-on voltage Von.

The data control signals CONT2 include a horizontal synchronization start signal STH for informing of start of data transmission for a group of pixels, a load signal LOAD for instructing to apply the data voltages to the data lines D₁-Dₘ, and a data clock signal HCLK. The data control signal CONT2 may further include an inversion signal RVS for reversing the polarity of the data voltages (with respect to the common voltage Vcom).

Responsive to the data control signals CONT2 from the signal controller 600, the data driver 500 receives a packet of the image data DAT for the group of pixels from the signal controller 600, converts the image data DAT into analog data voltages selected from the gray voltages supplied from the gray voltage generator 800, and applies the data voltages to the data lines D₁-Dₘ.

The gate driver 400 applies the gate-on voltage Von to the gate line G₁-Gₙ in response to the gate control signals CONT1 from the signal controller 600, thereby turning on the switching elements Q connected thereto. The data voltages applied to the data lines D₁-Dₘ are supplied to the pixels through the activated switching elements Q.

The difference between the data voltage and the common voltage Vcom is represented as a voltage across the LC capacitor C_{LC}, which is referred to as a pixel voltage. The LC molecules in the LC capacitor C_{CL} have orientations depending on the magnitude of the pixel voltage, and the molecular orientations determine the polarization of light passing through the LC layer 3. The polarizer(s) converts the light polarization into the light transmittance.

By repeating this procedure by a unit of the horizontal period (which is denoted by “1H” and equal to one period of the horizontal synchronization signal Hsync and the data enable signal DE), all gate lines G₁-Gₙ are sequentially supplied with the gate-on voltage Von during a frame, thereby applying the data voltages to all pixels. When the next frame starts after finishing one frame, the inversion control signal RVS applied to the data driver 500 is controlled such that the polarity of the data voltages is reversed (which is referred to as “frame inversion” ). The inversion control signal RVS may be also controlled such that the polarity of the data voltages flowing in a data line in one frame are reversed (for example, line inversion and dot inversion), or the polarity of the data voltages in one packet are reversed (for example, column inversion and dot inversion).

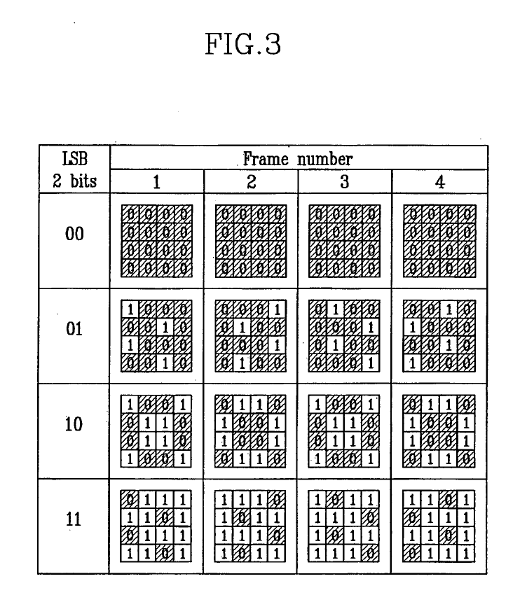

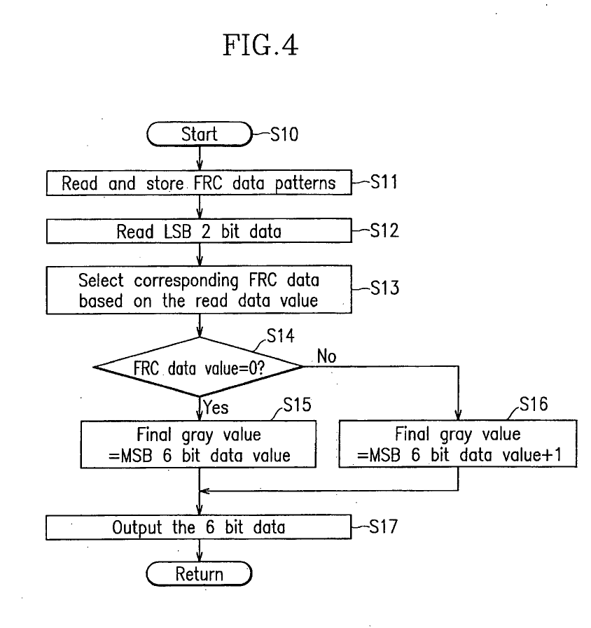

The FRC of the data processor 601 of the signal controller 600 according to an embodiment of the present invention is now described in detail with reference to FIGS. 3 and 4 as well as FIG. 1.

FIG. 3 is a set of FRC data patterns stored in a look-up table of a signal controller according to an embodiment of the preset invention and FIG. 4 is a flow chart of a data processor according to an embodiment of the present invention.

First, after the data processor 601 of the signal controller 600 starts (S10), the data processor 601 reads out FRC data patterns from the external memory 700 and stores them into the look-up table 602 (S11).

A set of exemplary FRC data patterns stored in the memory 700 is shown in FIG. 3. Referring to FIG. 3, a FRC data pattern is determined by lower two bits of input image data R, G and B and a serial number of a frame of the input image data R, G and B divided by four. The basic unit for a spatial arrangement of each FRC data pattern is a 4×4 data matrix including data elements and this means that the FRC data pattern is repeatedly applied to the pixels by a 4×4 pixel matrix.

In each FRC data pattern in FIG. 3, the number of data elements having a data value “0” and the number of data elements having a data value “1” are determined on the basis of the lower 2-bit data of the input image data R, G, and B, which is called dithering. For example, when the lower 2-bit data has a value “00,” all of sixteen data elements have the data value “0.” When the lower 2-bit data has a value “01,” twelve data element, i.e., ¾ of the sixteen data elements have the data value “1” and the remaining four data elements have the data value “0.” Furthermore, when the lower 2-bit data has a value “10,” eight data elements, i.e., 2/4 of the sixteen data elements have the data value “0” and the remaining eight data elements have the data value “1,” and when the lower 2-bit data has a value “11,” four data elements, i.e., ¼ of the sixteen data elements, have the data value “1” and the remaining twelve data elements have the data value “1.”

For data elements, each being disposed at a given position in a 4×4 data matrix, the number of the data elements having the value “0” and the value “1” for sequential four frames is defined by the lower 2-bit data. For example, when the lower 2-bit data has the value “00,” all the data elements for the four frames have the value “0.” When the lower 2-bit data has the value “01,” the data elements for three frames have the value “0” and the data element for remaining one frame has the value “1.” Similarly, when the lower 2-bit data has the value “10,” the data elements for two frames have the value “0” and the data elements for remaining two frames have the value “1,” and when the lower 2-bit data has the value “11,” the data element for one frame has the value “0” and the data elements for three frames have the value “1.”

When the 8-bit input image data R, G, and B are converted into the 6-bit image data DAT, the total number of the FRC data patterns required for temporal and spatial FRC are sixteen, i.e., four cases for the four data values 00, 01, 10, and 11 defined by the lower 2-bit data and four cases for successive four frames.

Referring to FIG. 3, when the lower 2-bit data of the input image data R, G, and B has the value “00,” all the data elements of the FRC data patterns for the successive four frames are “0.” Furthermore, the FRC data patterns for the lower-bit value “01” are the inversions of those for the lower-bit value “11.” That is, if a data element having the value “0” at a given position in a FRC pattern for the lower-bit value “01,” a data element at the given position in a corresponding FRC pattern for the lower-bit value “11” has the value “1” . Cn the contrary, a data element for the lower-bit value “11,” which corresponds to a data element for the lower-bit value “01” having the value “1,” has the value “0.”

Consequently, it is sufficient to store into the memory 700 eight FRC data patterns for the lower-bit values “01” and “10” among the sixteen FRC patterns shown in FIG. 3.

In the meantime, each of the 4×4 data matrices includes four 2×2 data matrices, the dithering is also applied to each of the four 2×2 data matrices. For example, when the lower 2-bit data has the value “01,” one data element among four data elements has the data value “1” and remaining three data elements have the data value “0.” Furthermore, when the lower 2-bit data has a value “10,” two of the four data elements have the data value “0” and remaining two data elements have the data value “1.”

Moreover, two 2×2 data matrices in each 4×4 data matrix are equal to the remaining two data matrixes, respectively. For example, when the lower 2-bit data has the value “01,” two 2×2 data matrixes in any column are equal to each other. However, corresponding 2×2 data matrices for four consecutive frames are different from one another. When the lower 2-bit data has the value “10,” the 2×2 data matrices facing in a diagonal in each FRC data pattern are equal to each other. The FRC data pattern for the first frame is equal to that for the third frame and the FRC data pattern for the second frame is equal to that for the fourth frame.

The set of the FRC data patterns shown in FIG. 3 is only an example for illustrating the present invention. The FRC data patterns may be varied depending on the difference in the bit number of the input image data R, G, and B and image data DAT to be processed in the data driver 500, and operating characteristics of the LCD.

After the data processor 601 reads out the FRC data patterns shown in FIG. 3 and storing them into the look-up table 602 as described above, the data processor 601 reads out the value of the lower 2-bit data of the input image data R, G, and B (S12), selects an appropriate one among the FRC data patterns based on the lower-bit value and the frame number, and selects an appropriate data element value in the selected FRC data pattern based on the positions of the pixels (S13).

When the value of the selected data element is “0” (S14), the data processor 601 determines a gray value defined by the upper 6-bit data of the input image data R, G, and B as a resultant gray value (S15) and outputs the upper 6-bit data to the data driver 500 (S17).

However, when the value of the selected data element is “1” (S14), the data processor 601 determines a gray value obtained by adding one to the gray value defined by the upper 6-bit data as a resultant gray value (S16) and outputs a corresponding output image data to the data driver 500 (S17).

Since the FRC data patterns are stored in the external memory 700 as described above, it is easy to change the FRC patterns depending on the operating conditions of the LCD by changing the values in the memory 700, thereby saving the time and the cost for changing the signal controller 600 for new FRC patterns.

Since each FRC data pattern has a 4×4 matrix form, the FRC data pattern is easily changed into a new FRC data pattern of such as a 4×2 data matrix or a 2×4 data matrix. Therefore, various FRC data patterns can be implemented without changing the memory 700. Moreover, a 4×2 data matrix or a 2×4 data matrix in a 4×4 data matrix may be used for a new FRC without changing the FRC pattern stored in the memory.

Furthermore, the FRC data patterns of 4×4 data matrices may be extended to FRC data patterns of an 8×8 data matrix or more. For example, when the difference between the bit numbers of input image data R, G, and B and the output image data DAT is three, an 8(=2³)×8 data matrix is used as a basic unit of a spatial arrangement for each FRC data pattern and FRC data patterns for 8(2³) frames may be prepared.

In the meantime, only the FRC data patterns for the lower-bit values “01” and “10” may be stored into the memory 700 as described above. In this case, when the lower 2-bit data has the value “00,” the data processor 601 outputs the upper 6-bit data of the input image data R, G and B to the data driver 500 as a resultant gray value. When the lower 2-bit data has the value “11,” the data processor 601 reads out a value of a corresponding data element of the FRC data patterns for the value “01,” inverts the read value, and regards the inverted value as the FRC data value. That is, when the lower 2-bit data has the value “11,” the data processor 601 uses the FRC data patterns for the value “01.”

Accordingly, the number of the FRC data patterns is decreased from sixteen to eight, thereby reducing the capacity of the memory 700 and the manufacturing cost.

The above-described can be adaptable to any type of display device.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A display device comprising:
a display panel including a plurality of pixels;
a memory storing a plurality of FRC data patterns;
a signal controller that reads out the FRC patterns, stores the FRC patterns therein, selects one of the FRC data patterns based on input image data having a first bit number, and converts the input image data into output image data having a second bit number smaller than the first bit number based on the selected FRC data pattern; and
a data driver applying data voltages corresponding to the output image data supplied from the signal controller to the pixels,
wherein the selection of the FRC data pattern is based on the lower bit data having a third bit number of the input image data and the frame number.

2. The display device of claim 1, wherein the signal controller further comprises:
a look-up table temporarily storing the FRC data patterns read out from the memory; and
a data processor converting the input image data into the output image data based on the FRC data patterns stored into the look-up table.

3. The display device of claim 2, wherein each FRC data pattern has an n×n data matrix form where n is equal to or larger than four.

4. The display device of claim 3, wherein the difference between the first bit number and the second number is equal to two and n is equal to four.

5. The display device of claim 4, wherein the third bit number is equal to two.

6. The display device of claim 5, wherein the FRC data patterns stored into the memory include FRC data patterns for values “01” and “10” of the lower bit data.

7. The display device of clam 6, wherein when the lower bit data has a value “00,” the data processor determines upper bit data of the input image data excluding out the lower 2-bit data as the output image data.

8. The display device of claim 7, wherein when the lower bit data has the value “11,” the data processor determines the output image data by using a data value obtained by inverting a data value of the FRC data patterns for the lower bit data having the value “01.”

9. The display device of claim 3, wherein the difference between the first bit number and the second bit number is three, and n is eight.

10. The display device of claim 1, wherein the memory comprises an EEPROM (electrically erasable and programmable read only memory).

11. A method for driving a display device, the method comprising:
reading out a plurality of FRC data patterns from an external device;
storing the read FRC data patterns;
reading out a value of lower bit data of input image data including upper bit data of the first bit number and the lower bit data of the second bit number;
selecting one of the FRC data patterns based on the lower bit data;
reading out a data value from the selected FRC data pattern corresponding to the input image data;
determining output image data as the upper bit data or the upper bit data added by one; and
outputting the output image data.

12. The method of claim 11, wherein each FRC data pattern has an n×n data matrix form where n is equal to or larger than four.

13. The method of claim 12, wherein the difference between the first bit number and the second bit number is equal to two and n is equal to four.

14. The method of claim 13, wherein the FRC data patterns include FRC data patterns for values “01” and “10” of the lower bit data.

15. The method of clam 14, wherein when the lower bit data has a value “00,” the data processor determines upper bit data of the input image data excluding out the lower 2-bit data as the output image data.

16. The method of claim 15, wherein when the lower bit data has the value “11,” the data processor determines the output image data by using a data value obtained by inverting a data value of the FRC data patterns for the lower bit data having the value “01.”
